(19) United States
(12) Patent Application Publication
(10) Pub. No.: US 2004/0239757 A1
(43) Pub. Date: Dec. 2, 2004

(54) Time sequenced user space segmentation for multiple program and 3D display

(76) Inventor: Ray M. Alden, Raleigh, NC (US)

Correspondence Address: Ray M. Alden, 808 Lake Brandon Trail, Raleigh, NC, 27610, US

(21) Appl. No.: 10/464,272

(22) Filed: Jun. 18, 2003

Related U.S. Application Data
(60) Provisional application No. 60/473,865, filed on May 29, 2003.

(51) Int. Cl. H04N 13/00

(52) U.S. Cl. 348/51; 348/42

(57) ABSTRACT

This invention provides a front projection display means which uses time sequenced addressing to physically segment viewer space into segments which each receive different respective full resolution image streams (or television programs). The display uses a pixel generation mechanism such as a DMD projector to generate a rapid succession of pixels which are rapidly swept across the viewer space using a variable deflector and/or reflector operating in rapid iterations in cooperation with the projector. First frame pixels from a first program are directed to a first viewer space segment, first frame pixels from a second program are directed to a second viewer space segment, and so on until all first frames from multiple programs are sent to applicable viewer space segments. Then the second frame is sent to each respective viewer space segment, and so on iteratively. A positionally segmented front projection display screen enables multiple viewers to each see full resolution programs on the same display screen concurrently. Alternately, a positionally segmented front projection display screen enables multiple viewers to each a different full resolution view of the same 3D image on the same display screen concurrently.

### CROSS REFERENCE TO RELATED APPLICATIONS

This application is a Continuation in part of a Patent Application of unknown number which was filed on Jun. 5, 2003 by the same title and which was a conversion of Provisional Application 60/473,865 filed with the USPTO on May 28, 2003.

### BACKGROUND FIELD OF INVENTION

Modern video monitors incorporate many technologies and methods for providing high quality video to users. Nearly every household in the United States has one or more video monitors in the form of a television or a computer monitor. These devices generally use technologies such as Cathode Ray Tubes (CRT) tubes, Liquid Crystal Displays (LCD), OLEDs, Plasma, Lasers, or Digital Micromirror Devices (DM) projection in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format.

The prior art describes some attempts to enable multiple viewers to see different image streams concurrently on the same monitor. These are generally drawn to wearing glasses that use polarization or light shutters to filter out the unwanted video stream while enabling the desired video stream to pass to the users' eyes. No prior art provides a technique to enable multiple viewers to view separate video streams concurrently with the unaided eye. Moreover, no display enables true 3D images or alternately multiple program images to be viewed from the same Television pixels at the same time by multiple viewers.

The present invention provides a significant step forward for video monitors. The present invention describes multiple embodiments which enable multiple high resolution video streams to be displayed on the same video monitor concurrently. Each embodiment describes the concurrent presentation and separation of video streams while using the same number of pixels as a typical display. In a preferred embodiment, beam steering optics cause the pixel to be time sequenced and swept across or moved to a range of positions across the user space thus dividing the user space into time sequenced positional segments where each segment receives different light from the same pixel. Thus the view one sees from the display is dependent upon the physical position he or she is in relative to the display. The result is that multiple users can sit in respective viewing segments wherein people in each of the segments can view different video streams on the same display concurrently. Alternately, viewers will see a true 3D image which is dependant upon their position relative to the display.

### BACKGROUND-DESCRIPTION OF PRIOR INVENTION

Many display screens have been described and practiced in the prior art. Modern video monitors incorporate many technologies and methods for providing high quality video to users. Nearly every household in the United States has one or more video monitors in the form of a television or a computer. These devices generally use technologies such as Cathode Ray Tubes (CRT) tubes, Liquid Crystal Displays (LCD), or Digital Micromirror Devices (DMD) in one way or another. Large monitors offer the advantage of enabling many users to see the video monitor simultaneously as in a living room for example. Often video users do not want to view the same video streams as one another.

The prior art describes some attempts to enable multiple viewers to see different video streams concurrently on the same monitor. These are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. No prior art provides a technique to enable multiple viewers to view separate video streams on the same monitor concurrently with the unaided eye as does the present invention.

### BRIEF SUMMARY

The invention described herein represents a significant improvement for the users of video monitors. Heretofore a large family size television for example could only carry one video stream on its entire surface at any given time. Anyone not interested in watching the same video stream was required to use a television in another room or in the case of “picture in picture” to view the video stream on a smaller portion of the same monitor. Likewise if a family member wanted to use the computer or video game, they would have to go to a separate computer or gaming station with a monitor. The present invention enables multiple users to use one video monitor concurrently while each views completely different video content concurrently whether television video, computer video, gaming video, or some other form of video.

The present invention also provides true 3D functionality in the same monitor as above.

The present invention uses a process of time sequenced iterative sweeping of pixels across the user space to physically segment the user space into physically segmented viewing spaces. As light from individual pixels is swept across the user space, each segmented viewing space receives a different color from individual pixels. This process is done concurrently for many thousands of pixels such that a multitude of positionally dependent normal resolution images are produced from the same video display device. Thus each respective space segment receives a different respective full resolution image from the display. Viewers in different segments can watch different programs at the same time. Alternately, each viewing space segment receives a perspective correct view of a true 3D image.

Users within respective user spaces each see unique video streams across the entire surface of the video display screen which are not visible to those in other respective user spaces. Using the techniques described, a multitude of video streams can be displayed concurrently on one video display screen. Examples of front projection LCD screen beam steering and front projection moving mirror beam steering projection embodiments are described which can be used with many types of pixel generating mechanisms.

Thus the present invention offers a significant advancement in the functionality of video monitors or displays without diminishing resolution.

### OBJECTS AND ADVANTAGES

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience true 3D enhanced media. Also, electrical energy can be saved by concentrating visible light energy from a display into narrower user space when just one person is using a display. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented 3D images and stereoscopic images.

It is an advantage of the present invention that resolution is not sacrificed in order to achieve 3D images and neither is resolution sacrificed to present multiple concurrent positionally segmented image streams and neither is resolution sacrificed to present stereoscopic image streams.

Further objects and advantages will become apparent from the enclosed figures and specifications.

### DRAWING FIGURES

FIG. 1 prior art illustrates a well know front projection method.

FIG. 2 illustrates a front projection system using a beam steering screen method of the present invention.

FIG. 3 illustrates a front projection system using a beam steering screen method including time sequenced viewer space addressing of the present invention.

FIG. 4 illustrates a front projection system using a beam steering screen method including time sequencing to deliver separate programs to segments of viewer space.

FIG. 5 illustrates a front projection system using a beam steering screen method including time sequencing to deliver true 3D images to viewer space.

FIG. 6 illustrates multiple pixels from a front projection system using a beam steering screen method including time sequencing to deliver true 3D images to viewer space.

FIG. 7 illustrates multiple pixels directed by head tracking from a front projection system using a beam steering screen method including time sequencing to deliver true 3D images to viewer space.

FIG. 8 illustrates a front projection system of the present invention with integrated screen position sensing.

FIG. 9 illustrates a pixel located in the beam steering screen of the present invention.

FIG. 10 illustrates a top view of the beam steering pixel of FIG. 9.

FIG. 11 illustrates an alternate pixel configuration located in the beam steering screen of the present invention.

FIG. 12 illustrates the reflective surface of the beam steering screen of the present invention.

FIG. 13 illustrates an alternate reflective surface of the beam steering screen of the present invention.

FIG. 14 illustrates a second embodiment of the front projection beam steering display of the present invention in a first position.

FIG. 15 illustrates the second embodiment of the front projection beam steering display of the present invention in a second position.

### DETAILED DESCRIPTION OF THE INVENTION

Preferred Embodiment—Solid State Beam Steering

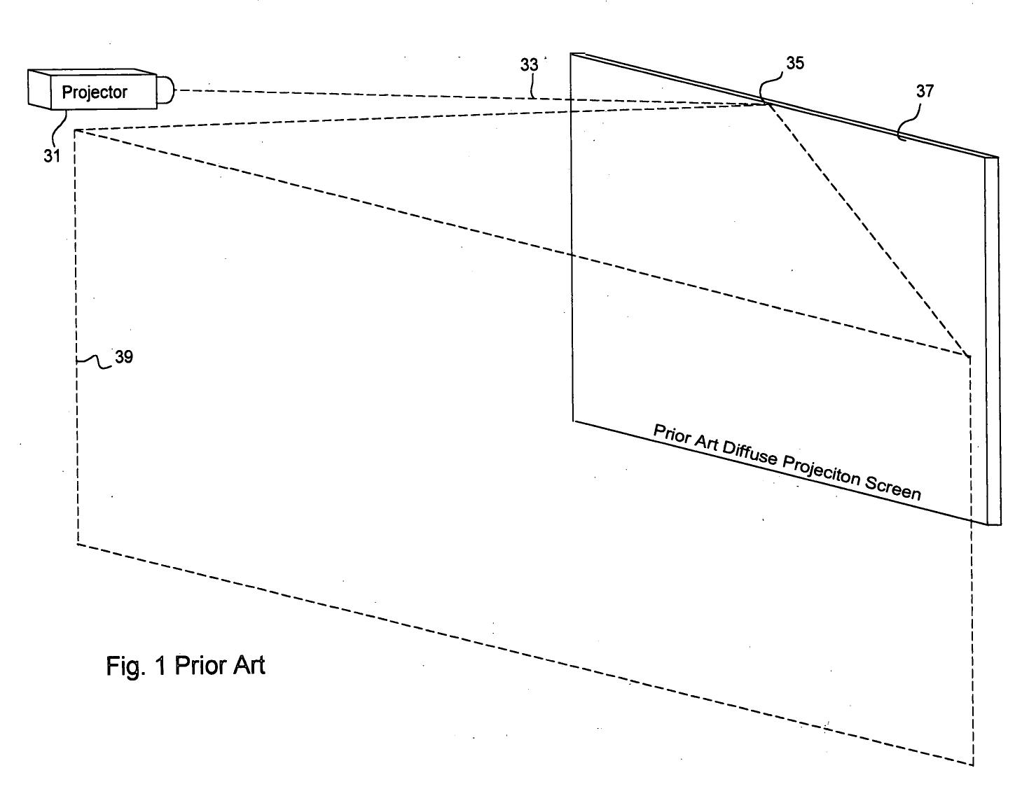

FIG. 1 prior art illustrates a well know front projection method. A prior art image projector 31 uses standard DMD or LCD technology to project an image including an individual prior art pixel 33 which is incident upon a diffuse projection screen 37. The 33 is incident the 37 at prior art incidence point 35. The entire prior art user space 39 is able to observe light from 33 that is diffuse by 37 at point 35. Similarly, each pixel is incident upon the surface of 37 and observable in 39. This prior art architecture is not conducive to displaying full resolution multiple programs concurrently using front projection without the aid of special shutter, polarized, or other types of glasses. Similarly, this prior art architecture is not conducive to displaying stereoscopic images or true 3D full resolution images concurrently using front projection without the aid of special shutter, polarized, or other types of glasses.

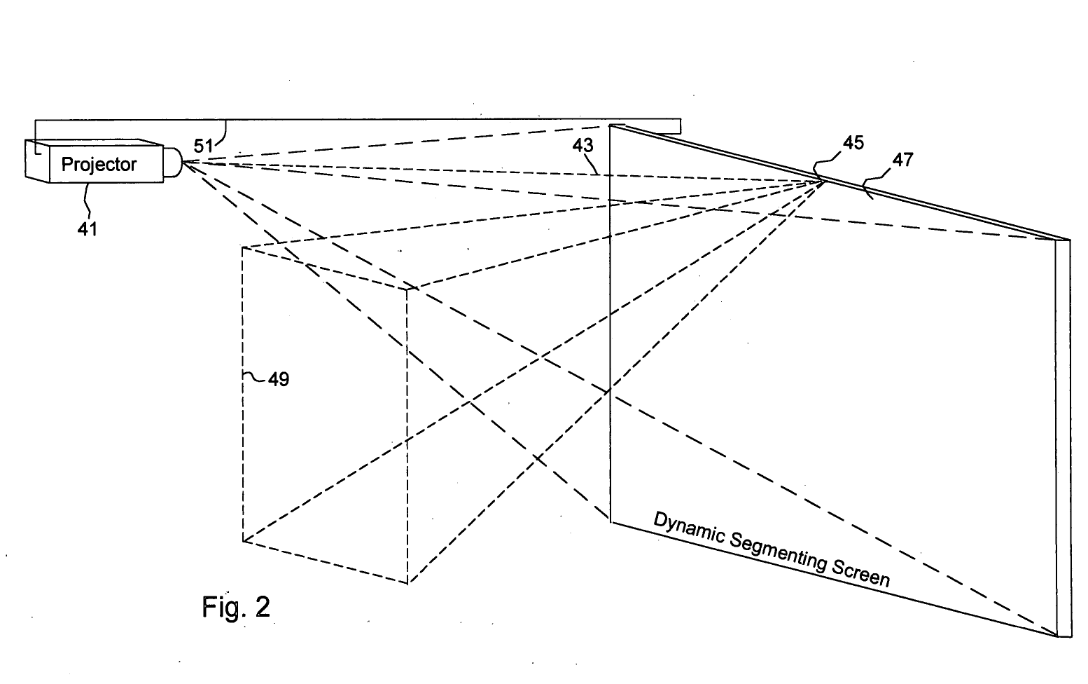

FIG. 2 illustrates a front projection system using a beam steering screen method of the present invention. A synchronized image projector 41 operates in sync with a time sequenced beam steering screen 47. Communication wire 51 carriers a synchronizing signal from 41 to 47. The 41 is a standard image projector of the prior art except that it is able to accept and time sequentially project multiple video streams in a rapid iterative process. The 41 is also able to rapidly switch iteratively between projecting the first half of a stereoscopic image and then the second half of a stereoscopic image. The 41 is also able to project in rapid succession a series of 2d views representative of a series of perspectives of an image which are perceived as 3D by viewers of the projected image as described later. The 41 projects a stream of pixels including an individual pixel 43. The 43 is incident upon a beam steering reflective screen 47 at pixel steering area 45. The characteristics of 45 and 47 are further described in FIGS. 9 through 13. At any given point in time, the 47 reflects and directs the 43 to a narrow viewer space segment 49.

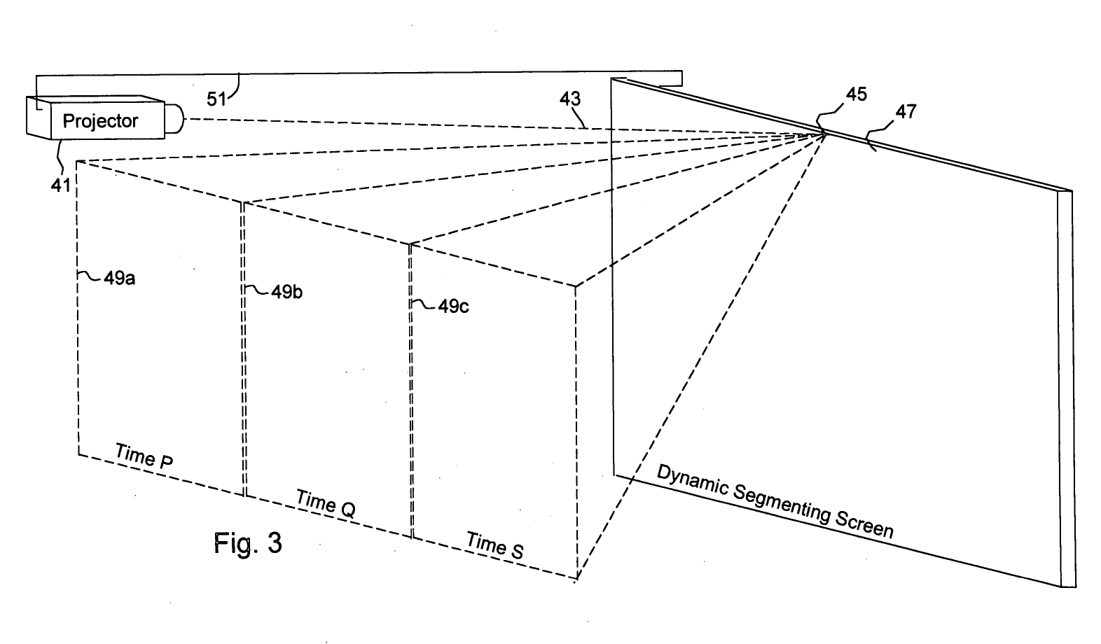

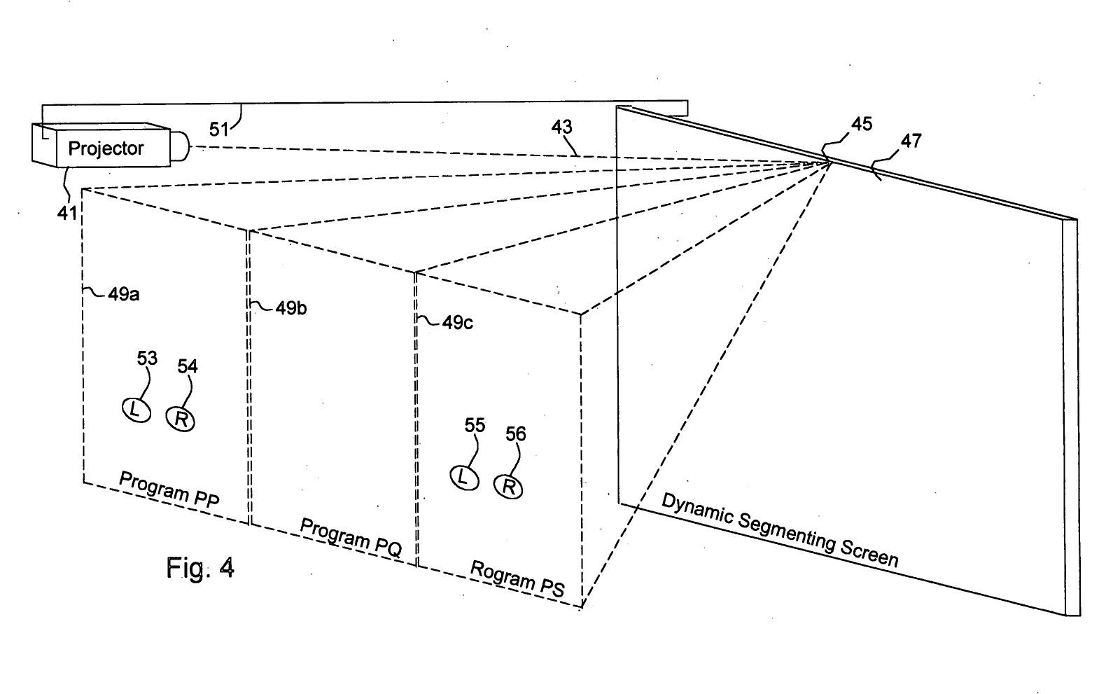

FIG. 3 illustrates a front projection system using a beam steering screen method including time sequenced viewer space addressing of the present invention. As 41 is operated over a period of time, 47 steers incident beams into successive segments of viewer space. A first viewer space segment 49a receives light from pixel 43 as steered by 45 at a first Time P. A second viewer space segment 49b receives light from pixel 43 as steered by 45 at a second Time Q. A Third viewer space segment 49a receives fight from pixel 43 as steered by 45 at a third Time S. The 43 and 45 represent the steering of a single pixel over a very rapid period of time. In practice, many pixels are concurrently projected from 41, incident upon and steered by 47 into segmented viewer spaces similar to the single pixel illustrated. The 41 and 47 are synchronized such that pixels from different images are directed to 49a, 49b, and 49c as discussed under FIGS. 4 through 7.

FIG. 4 illustrates a front projection system using a beam steering screen method including time sequencing to deliver separate programs to segments of viewer space. The 41 sends a pixel representative of a first video “Program PP” into 49a such that a first viewer's left eye 53 and a first viewer's right eye 54 sees the pixel (along with thousands of other current pixels as later described). The 41 then sends a signal to 47 to change its beam steering direction as later described such that a pixel from another concurrently displayed program Program PQ is projected from 41, reflected and steered into 49b by 45. The 41 then sends a signal to 47 to change its beam steering direction as later described such that a pixel from another concurrently displayed program, Program PS, is projected into 49c such that a second viewer's left eye 55 and a second viewer's right eye 56 observe the pixel from the third video. The 41 in sync with 47 and 45 then interactively repeats the process very rapidly such that a stream of pixels from the PP Program are sent to 49a and viewed as an uninterrupted stream by 53 and 54 while concurrently a stream of pixels from the PS Program are sent to 49c and viewed as an uninterrupted stream by 55 and 56. The first viewer is watching a first full resolution program while the second viewer is watching a different full resolution program on the same display screen at the same time.

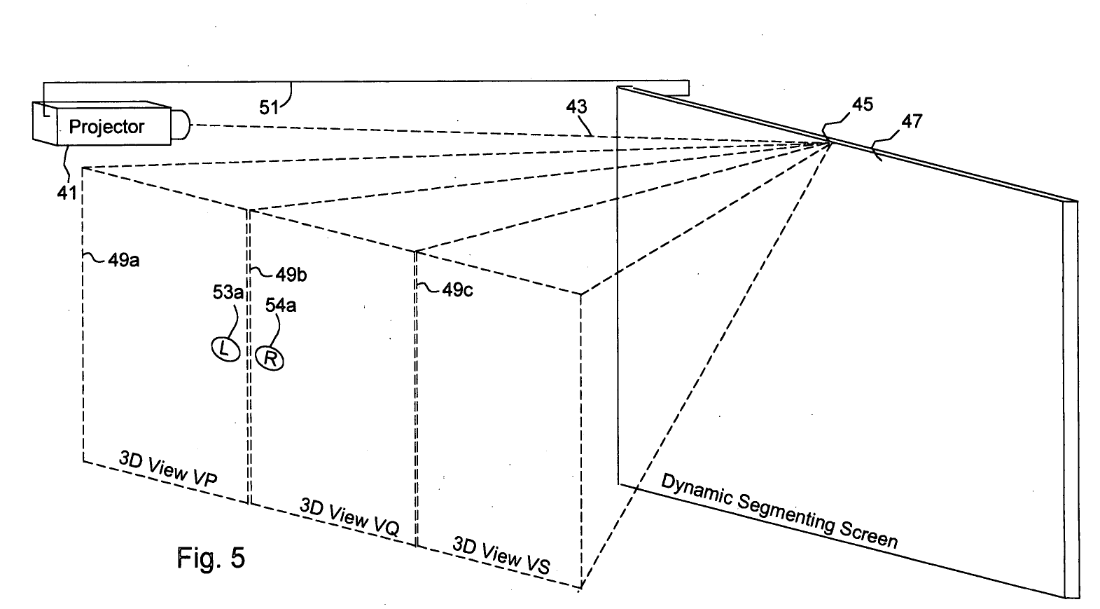

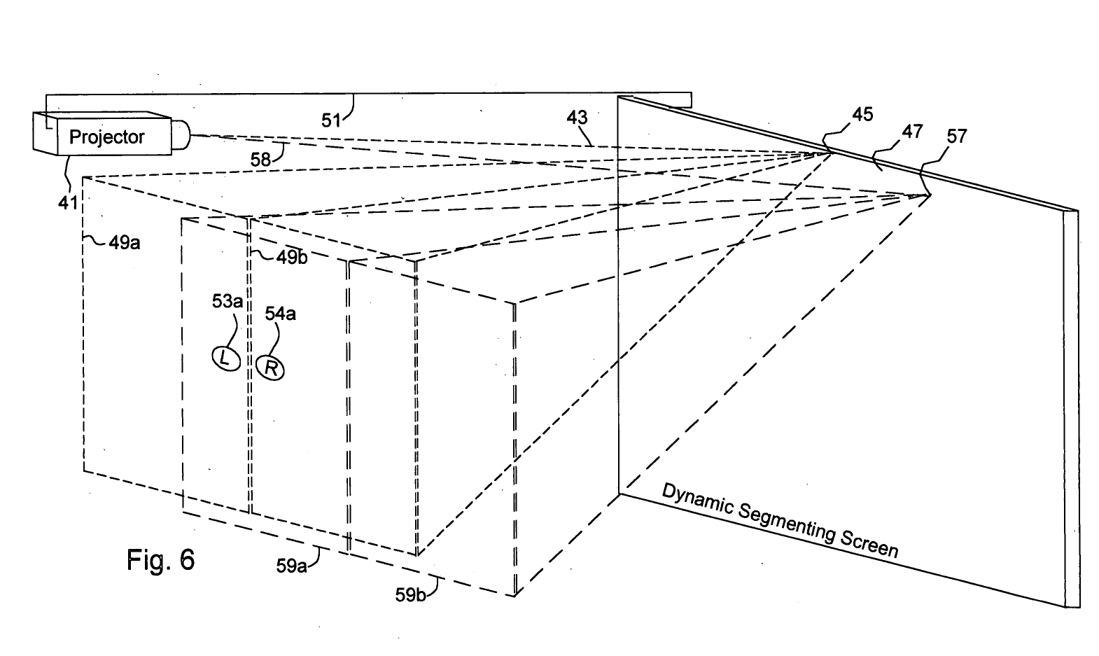

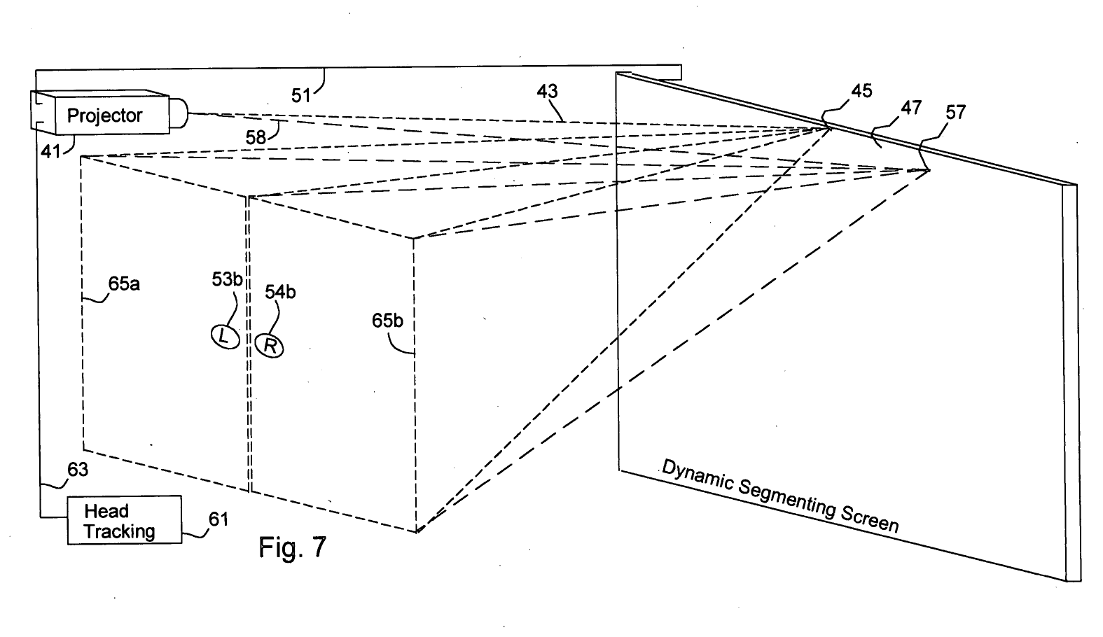

FIG. 5 illustrates a front projection system using a beam steering screen method including time sequencing to deliver true 3D images to viewer space. Here a first alternate viewer's left eye 53a receives pixel light representative of a first perspective 3D View VP 49a while in rapid succession, a first alternate viewer's right eye 54a receives pixel light representative of a second perspective 3D View VP 49b. The 41 and 45 produce and steer a rapid succession of pixels representative of two different views in an iterative process. Thus the first alternate viewer sees a true 3D image coming from 43 as directed by 45. Many true 3D pixels are similarly concurrently produced by 41 and directed by 47 as described in FIGS. 6 and 7.

FIG. 6 illustrates multiple pixels from a front projection system using a beam steering screen method including time sequencing to deliver true 3D images to viewer space. The 41 projects a second individual pixel 58 along with the 51 ad thousands of other pixels not show. The 58 is incident on the 47 at a second steering area 57. The 57 operates in sync with 41, 47, and 45 such that when the 43 pixel is directed to 49a, the 58 pixel is directed to a fourth viewer space segment and when the 43 pixel is directed to 49b, the 58 pixel is directed to a fifth viewer space segment 59b. The light in 59a is a pixel representing the 3D image of FIG. 5 from a first perspective and the 59b is a pixel representing the 3D image of FIG. 5 from a second perspective. Note that in the illustration, the 3D parallax resolution is low such that the 53a and the 54a each receive light from the same perspective of the 58 pixel.

It is noteworthy that if each directing area of the 47 directs light at the same angles concurrently, a viewer in a particular segment may receive light from some pixels which was emitted at a first time and light from other pixels that was emitted at a second time. This process enables blending of a finite number of 2D image perspectives of a 3D image to produce a far greater number of 3D viewing possibilities. For example, if 53a and 53b were closer to the 47 display screen, they would see different viewing perspectives of both 43 and 58, thus the user would experience 3D depth perception when moving around relative to the display whether moving horizontally on an X axis of an imaginary coordinate system or moving toward or away from the display on an imaginary Z axis. Also, horizontal parallax resolution much greater than that show in the illustration is available using current state of the art DMDs such as Texas Instruments' DLP product line. Using the later, it may be possible to show forty 2D image views of each frame, each projected into a respective segment of user space to achieve very high resolution true 3D images which when blending of images is taken into account yields hundreds of thousands of unique 3D viewing positions on the imaginary X and Z coordinate system. Multiple users moving around in the user space will each experience true 3D.

FIG. 7 illustrates multiple pixels directed by head tracking from a front projection system using a beam steering screen method including time sequencing to deliver true 3D images to viewer space. A head tracking system 61 is integrated into 41. The 61 senses the position of one or more viewers using the display screen. A CPU in 41 calculates the image that should be sent to a second alternate viewer's left eye 53b and to a second alternate user's right eye 54b. When using head gear, 41 can generate images that are perspective correct for multiple stereoscopic viewers. A first image includes a 43 pixel which is sent to the a first common viewer space 65a and at the same time the correct perspective 58 pixel is sent to 65a and both of these are observed by 53b. Concurrently, a second image includes a 43 pixel which is sent to the a second common viewer space 65b and at the same time the correct perspective 58 pixel is sent to 65b and both of these are observed by 54b. All pixels in a first image are likewise sent to 65a and all pixels in the second image are sent to 65b. Thus the second alternate viewer perceives a stereoscopic 3D image that will change as the viewer changes.

Using the 61 input and the CPU to calculate correct perspective images and to control the pixel steering in 47, the 41 need only generate two images for each viewer in order to project a true 3D experience. In order to achieve this functionality, the 45 and 57 must be independently controllable as well as the other similar areas corresponding to the steering control mechanism for the thousands of pixels from 41. This is a contrast with the operation of FIG. 6 which does not employ control of the individual pixel steering elements of 47. In FIG. 6, all of the steering elements operate in unison as later described, each sweeping pixels streams across the users space in synch with 41.

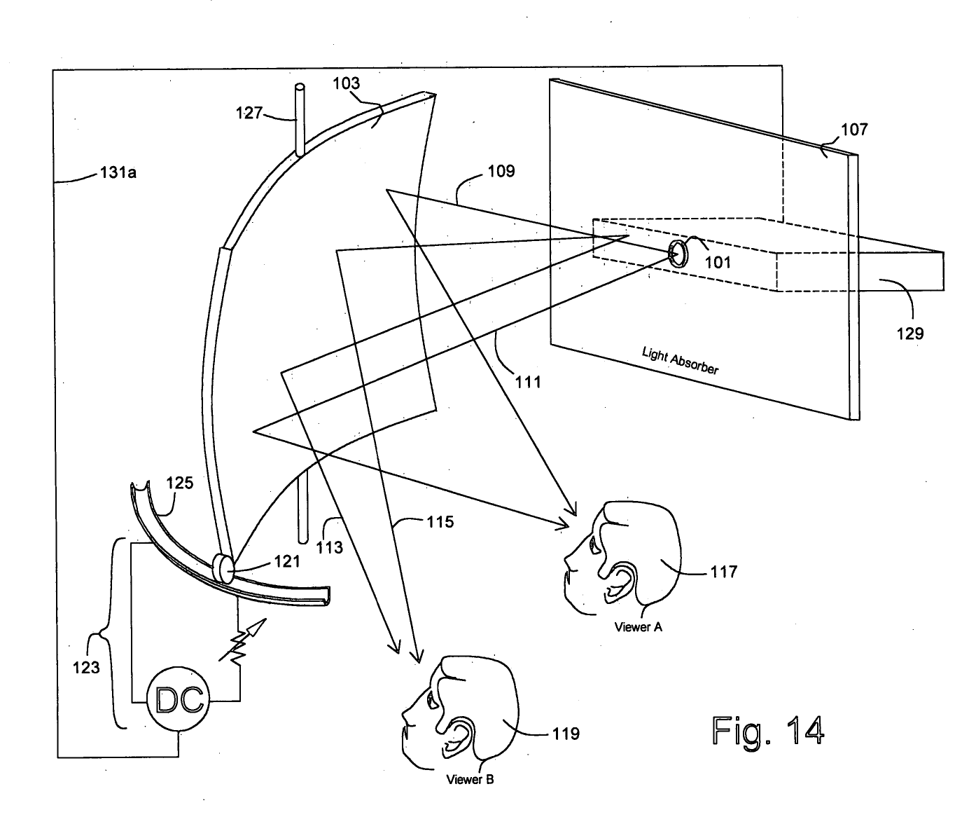

Note that as an alternate to using head tracking to deliver true 3D images, 47 can be curved similarly to a reflector described in FIG. 14.

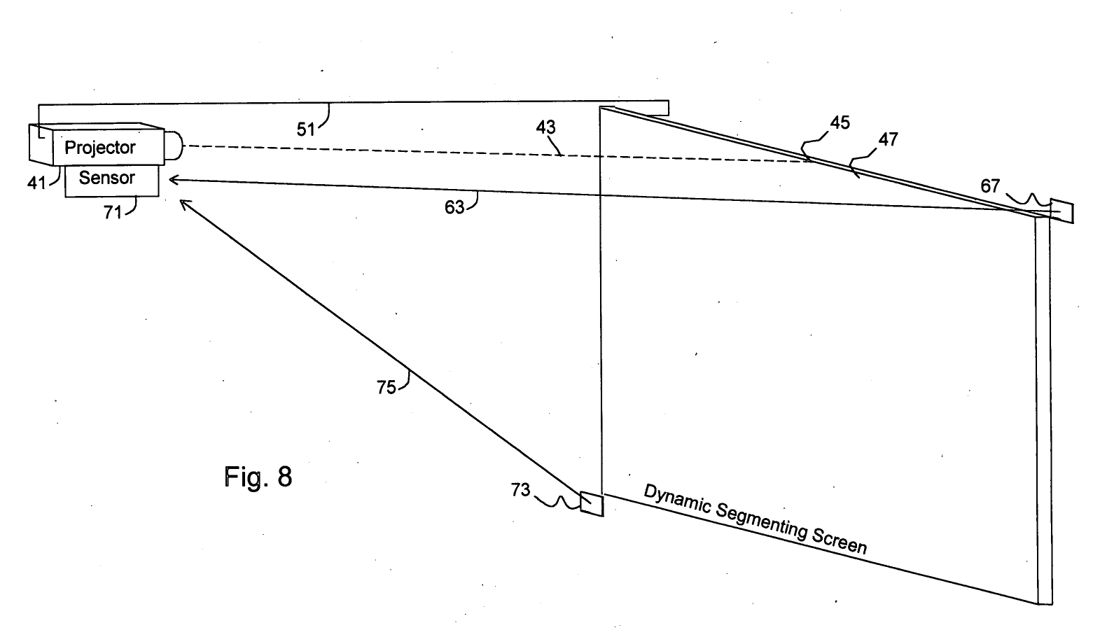

FIG. 8 illustrates a front projection system of the present invention with integrated screen position sensing. In some applications, it may be useful to for the 41 to know where the 47 is located. In such applications, a first IR emitter 67 emits a first beacon signal 63 which is sensed by a beacon sensor 71. Similarly, a second IR emitter 73 emits a second beacon signal 75 which is sensed by the 71 using triangulation, 71 reports the distance and position of 47 to 41 where a CPU uses the information to calculate self adjusting focus and where to send pixels.

FIG. 9 illustrates a pixel located in the beam steering screen of the present invention. The 45 consists of a portion of a liquid crystal cell. In practice, the liquid crystal cell is a large structure that concurrently steers thousands of pixel but for illustrative purposes, only one small area which steers a single pixel is described as 45. A first transparent substrate 77 with integral conductor forms the first side of the liquid crystal cell and contains the first liquid crystal 81. A second transparent substrate with integral conductor 79 forms the second side of the liquid crystal cell. Thus the 81 is sandwiched between two substrates with integral conductors. The conductors are wired to a circuit which provides current to sections of the current to create liquid crystal features that can steer light in response to the location and/or intensity of an electric current. The liquid crystal cell can employ variable refraction, variable diffraction, and/or another means to deflect pixel 43 in a desirable and controllable manner. One method of preparing and controlling the beam deflecting properties of a liquid crystal is described in SID 03 Digest by J. L. West of Kent State University and which is available from Society for Information Display and more other methods have been described in the prior art. Speed and deflection angle are two important consideration when selecting a beam deflection technique using liquid crystals. Behind the liquid crystal cell is a concave mirror reflector 83. The 83 comprises a single channel which is among thousands of parallel channels which are molded into a substrate which is coated with a highly reflective smooth material such, as aluminum or chrome. In operation, a first screen control circuit 85 produces an electric field between the 77 and the 79 and in the 81 such that the deflecting properties of 81 are time synchronized with the 41. As time progresses, the 41 controls the 85 which controls the 77 and 79 conductors which causes the 81 to run through a rapid succession of deflection properties in an iterative process. The 43 pixel is incident on 81 and is cause to be deflected prior to being incident upon 83. The 83 reflects the 43 which again passes through the 81 and exists the cell as deflected and reflected light 49c due to the concavity of 83, the 49c has a greater vertical divergence that it did when it was incident upon 77. This is the manor by which many thousands of pixels are directed to discrete segments of user space in sync with the 41 rapidly switching between images to be sent to each segment of user space. It comprises time sequenced addressing of user space through the controlled deflection of a reflective display screen

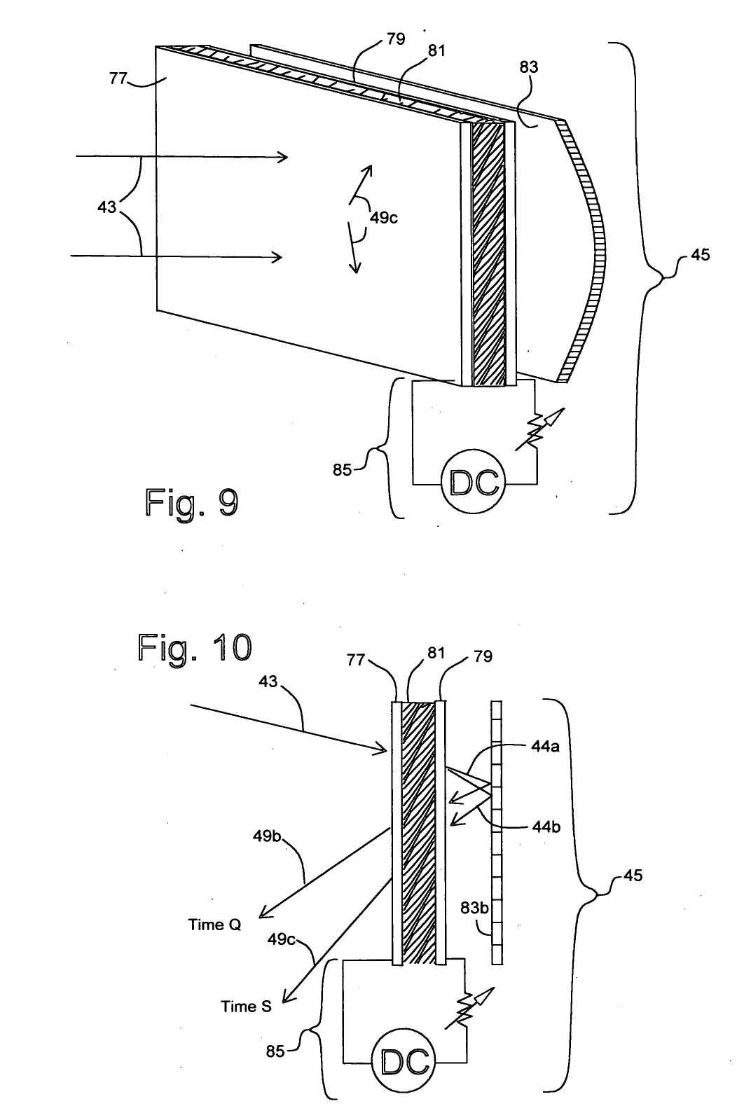

FIG. 10 illustrates a top view of the beam steering pixel of FIG. 9. As the 43 passes through the 81, it is deflected from its original trajectory. The liquid crystal deflects the 43 beam at a second Time Q as second deflected beam 44a which is then reflected by a flat mirror reflector 83b. The 83b directs the 44a back through the 81, where it is deflected more and exists the cell as 49b in Time Q. A viewer in the 49b space segment sees this pixel. Then in Time S, the 43 pixel is part of a different image and is deflected by 81 to become third deflected pixel 44b. Note the 44b has been deflected by 81 greater that was 44a. After being reflected by 83b, the 44b passes back through the 81 and exits as 49c. A viewer in the 49c user space segment sees this pixel. The 41 similarly generates many thousands of pixels similar to 43 but incident on different areas of the 47 beam reflecting and steering display screen. Each of these many thousands of pixels are sequential directed to a multitude of users space segments in a rapid iterative process. A viewer in a single respective user space segment sees a stream of images on the display screen which may be completely different from the stream of images that a different user in a different space segment sees. Alternate both viewers may see different perspectives of the same 3D image.

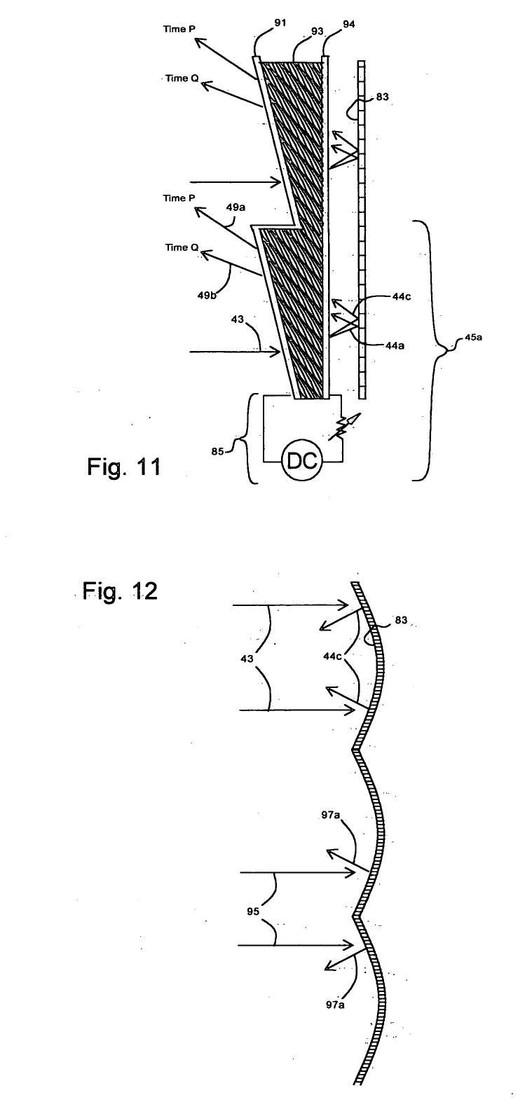

FIG. 11 illustrates an alternate pixel configuration located in the beam steering screen of the present invention. An alternate transparent substrate with integral conductors 91 forms the first side of a portion of a large liquid crystal cell and contains a second liquid crystal 93 on a first side. The 93 is contained on a second side by a second alternate substrate with integral conductors. The 91, 93, 94 assembly operates similarly to that described in FIGS. 9 and 10 except that the 91 and 94 are not parallel to one another. In some liquid crystal deflecting cells employing refraction, deflection, and/or another deflection method, employing a prism shaped liquid crystal layer is useful.

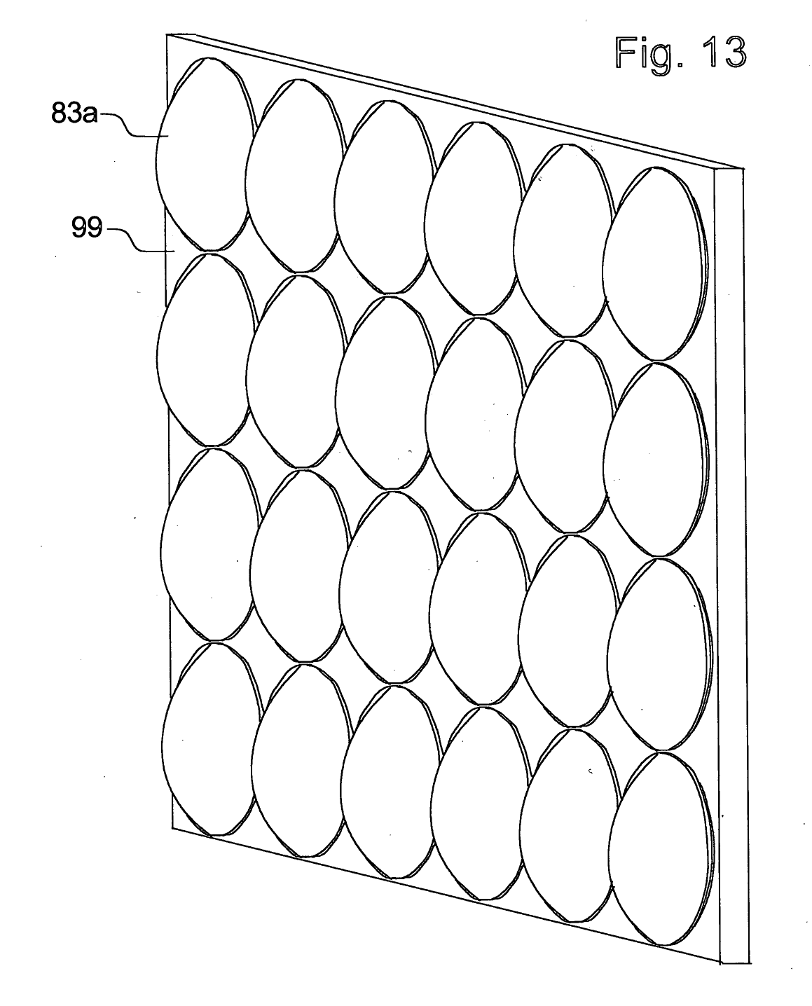

FIG. 12 illustrates the reflective surface of the beam steering screen of the present invention. When using the 83 concave shaped reflector is array, it is important to note that since the individual concavities are pixel size, The individual incident pixels need not be exactly incident within the individual concavities. If the 43 pixel is incident upon the 83 in a lined up fashion, it produces a first set horizontally divergent beams 44c. If the off centered pixel 95 is incident across two concavities, it produces a second set of divergent beams 97a. 44c and 97a are equally divergent and equally cover the same amount of viewer space.

FIG. 13 illustrates an alternate reflective surface of the beam steering screen of the present invention. Reflectors need not be concave channels as is 83, but can be convex structures as well. A convex reflector 83a is one of thousands of convex sections on a molded substrate which is coated with smooth aluminum or chrome mirror material.

Alternate Embodiment—Mechanical Beam Steering

FIG. 14 illustrates a second embodiment of the front projection beam steering display of the present invention in a first position. An alternate projector 129 is synchronized with a magnetic actuating circuit 123 via an actuating control wire 131a. The 129 produces a control signal that controls the 123 such that a magnetic impulse is produce in an electromagnetic channel 125. I response to the electric field created in the 125, a permanent magnet 121 is pushed or pulled into a desired position. The 121 is rigidly affixed to a concave mirror display screen 103 which is able to rotate along a to axis 127 and a similar bottom axis. The 103 is a molded plastic mirror which is smooth coated with a highly reflected material such as aluminum or chrome. The 103 has an array of horizontal channels similar to those described in FIG. 12 for increasing a pixels vertical distribution in viewer space. The 129 is adapted to generate a controlling signal which positions the 103 in sync with a rapidly iterative sequence of pixels representing at least two distinct image streams. The 129 is behind a light absorber 107 with the only part of the 1299 protruding through the 107 being a projection lens 101. The 107 is comprised of a rigid plastic sheet with a flat black light absorbing coating either painted on its surface or affixed to its surface distributing a pixel. At a first time, The 129 produces thousands of pixels including a first viewer's first pixel 109 and a first viewer's second pixel 111. The 109 and the 111 are both incident on 103 and directed to at least one eye of a first viewer A 117. The curvature of 103 is such that all of the concurrently generated pixels from 129 are sent to at least one eye of 117. If the 117 is watching a 2D program, the pixels from 103 can be sent to both eyes of 117 as described in FIG. 4. If the 117 is watching a 3D program, 103 in conjunction with 129 needs to send different pixels respectively to the right eye and to the left eye of 117 as is described in FIGS. 5 through 7. While 117 can see pixels generated at the instance depicted in FIG. 14, A second viewer B 119 receives light from light absorber 107 as reflected from 103 as first non-visible light 1143 and second non visible light 115. In other words, the 103 is reflecting light from the 107 to the 119 which can not be seen by the 119. Similarly, 119 does not perceive any image from the entire surface of the 103 during the depicted instant while 117 does perceive an image on the entire surface of the 103 reflective screen.

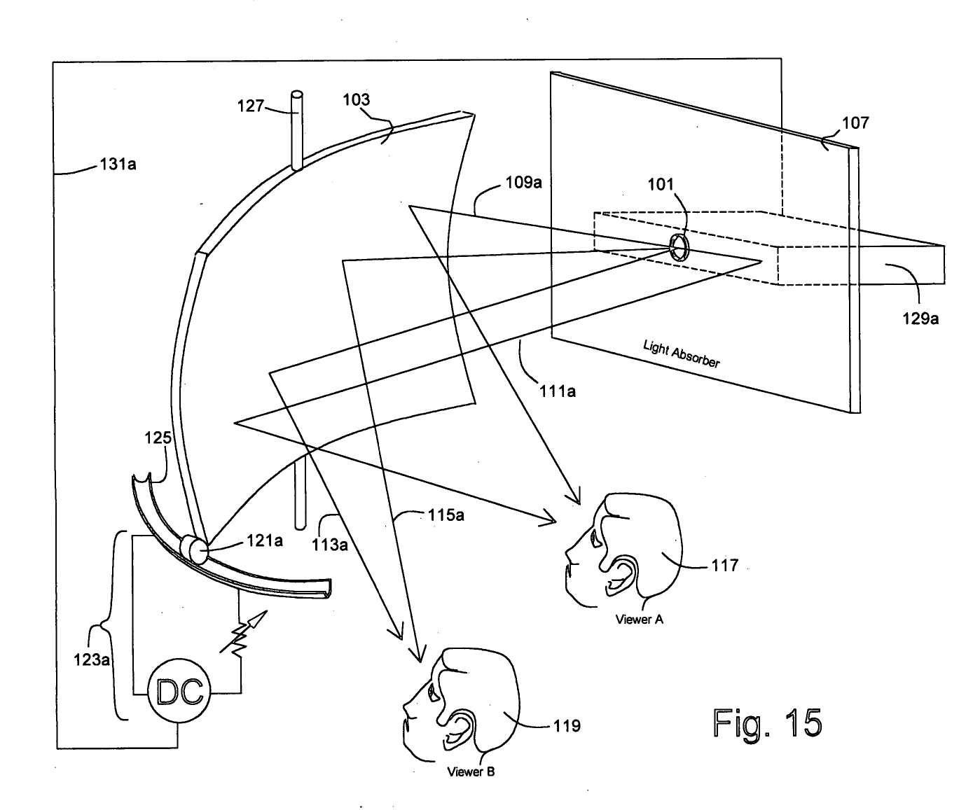

FIG. 15 illustrates the second embodiment of the front projection beam steering display of the present invention in a second position. FIG. 15 depicts the next instant in time as compared to FIG. 14. A first projector in a second time instance 129a has sent a signal via a wire carrying a second control signal 131a that causes a second time instant magnetic control circuit 123a to produce a second magnetic field characteristic in the 125 magnetic channel such that an actuated permanent magnet 121a has been moved and thereby the 103 rotated around the 127 into a new reflecting position. In this new reflecting position, the 117 sees invisible light from the 107 reflected off the entire surface of 103 and including first viewer's first non-visible light 109a and first viewer's second non-visible light 11a. In the depicted instant in time, 119 can see many thousands of pixels reflected from the 103 including realigned including second viewer's first 25 visible pixel 113a and second viewer's second visible pixel 115a. Thus in his instance of time, the first viewer perceives nothing while the second viewer perceives and image.

Thus as depicted in FIGS. 14 and 15, the 129 in conjunction with the 103 projects at least two distinct image streams (possibly four distinct image streams in the case of true 3D) with one image stream viewed by the 117 and the other image stream viewed by the 119. The 103 is very rapidly actuated between the two positions in sync with the 129a which very rapidly in alternate frames projects two image streams representative of two distinct programs (or multiple 3D views). While the discussions of FIGS. 14 and 15 include two or four images, currently available DMDs for projectors including Texas Instruments' DLP line and compatible herewith can produce as many as forty concurrent image streams.

### OPERATION OF THE INVENTION

Operation of the invention has been discussed under the above heading and is not repeated here to avoid redundancy.

### CONCLUSION, RAMIFICATIONS, AND SCOPE

Thus the reader will see that the Time Sequenced User Space Segmentation For Multiple Program and 3D Display of this invention provides a novel unanticipated, highly functional and reliable means for distributing multiple video streams to segmented user spaces such that users within each respective space can view distinct video streams or true 3D views of the same video stream.

While my above description describes many specifications, these should not be construed as limitations on the scope of the invention, but rather as an exemplification of a preferred embodiment thereof. Many other variations are possible. Many types of video monitors are well known and can be used with the method and elements described herein. For example, many techniques for projecting images are well known and could be used by one skilled in the art to physically segment multiple video streams according to the present invention. Many optical elements and combinations thereof are possible. Many optical arrangements of intervening optics have been described herein and others are possible using that which is taught herein. Many reflector configurations are possible. Many solid state beam steering or deflecting techniques are known in the prior art. It should be understood that the term “display” and/or “screen” refers to a screen for receiving a projection, video monitor, television screen, a computer display, a video game screen, or device which substantially provides images to a user.

The prior related patent applications of the present applicant which are cross referenced herein also contain relevant information which is incorporated herein but not repeated to avoid redundancy.

What is claimed:

1. An image display system for providing a first image to a first portion of user space and a second image to a second portion of user space wherein a user in the first portion of space can see the first image but can not see the second image and wherein time sequencing is used to direct images to each respective user space.
